(19) United States
(12) Patent Application Publication
(10) Pub. No.: US 2004/0126099 A1
(43) Pub. Date: Jul. 1, 2004

(54) Filming apparatus, DVD camera

(76) Inventors: Koji Mori, Naka (JP); Keiici Tadokoro, Mito (JP); Eisuke Sengoku, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/449,481

(22) Filed: Jun. 2, 2003

(30) Foreign Application Priority Data
Dec. 27, 2002 (JP) 2002-378949

(51) Int. Cl. H04N 5/76; H04N 5/225; H04N 5/781

(52) U.S. Cl. 386/117; 386/125

(57) ABSTRACT

To reduce the size of a filming apparatus for recording information on an optical disc type recording medium, it is constructed such that: supporting portions for mounting a grip belt are provided on two structural members (not a cartridge cover) constituting a main body, respectively arranged on both sides of the filming apparatus; the optical disc is inserted or removed vertically with respect to a filming direction; a round-shaped cartridge is used as a cartridge whose dimension is: 5.2 mm in thickness, 80 mm in length (or width) of the disc plane, and 80 mm+5 mm in width (or length) of the disc plane; the angle between the opened cartridge cover and the filming apparatus to the line along an axis of supporting points of the cartridge cover is within the range from 23° to 34°; and a motor is used to open the cartridge cover.

### BACKGROUND OF THE INVENTION

The present invention relates to a filming apparatus for recording information on a disc-type recording medium. A portable camera (hereinafter, “a camera” will refer to “a filming apparatus”) has a grip belt to hold back of a person's hand for preventing an accident of dropping off the camera if a user might loosen his or her grasp. Recently, a portable IT device containing an exchangeable disc for recording information appears on the market. As one example of such IT device, there is a camera utilizing, as information recording medium, an optical disc as represented by DVD (Digital Versatile Disc) (hereinafter, referred to as a “DVD camera”). In a mechanism of the DVD camera where a grip belt supporting portion is mounted, the optical disc is encased in a square-shaped cartridge, and a direction of insertion or removal of the square-shaped cartridge in/from the DVD camera is parallel to a filming direction. Further, the insertion/removal of the square-shaped cartridge is performed from the side of a cameraperson. One end of the grip belt supporting portion is provided on a cartridge cover so as not to interfere with the insertion/removal of the square-shaped cartridge from the cameraperson side. This conventional art will be explained hereinafter referring to FIG. 1 to FIG. 4.

FIG. 1 is a perspective view of a conventional DVD camera. The mechanism for mounting the grip belt supporting portion comprises a supporting portion E provided on the cartridge cover 2, and a grip belt 3, being supported at a supporting portion F that is fixed on a grip side cover 14, which is a part of the camera main body. A user puts his/her right hand between the grip belt 3 and the cartridge cover 2, thereby functioning as a grip to hold the DVD camera 1. When the cartridge cover 2 is closed, a lock mechanism for fixing the cartridge cover onto the main body is provided on a part of the supporting portion E.

FIG. 2 is a perspective view showing a state where the square-shaped cartridge 4 is removed from the DVD camera 1. By operating the cover operation button 5, the cartridge cover 2 is opened into the direction A, and the square-shaped cartridge 4 can be inserted or removed in the direction B.

FIG. 3 shows a positional relationship between a disc loading unit 11 of the DVD camera 1 and the square-shaped cartridge 4 when it is inserted or removed in/from the disc loading unit 11. Similar to the explanation regarding FIG. 2, the square-shaped cartridge 4 is inserted or removed in the direction B.

FIG. 4 is an illustration of the cartridge cover 2, which is arranged in such a manner that the right-lower surface of the cover as shown in FIG. 2 faces the front. As explained in FIG. 1, the grip belt 3 is supported at the supporting portion E and the supporting portion F. G indicates an axis of supporting points for opening/closing the cartridge cover 2.

In the conventional art as described above, there have been problems to be solved as the following; reduction of space for a lock mechanism, reduction of space for an opening-support button to open the cartridge cover, reduction of space for a cartridge, and reduction of a reinforcing member at the axis of supporting points of the cartridge cover. Furthermore, there is another problem that, if the cartridge cover is opened too widely when the cartridge is inserted, inadequate insertion of the cartridge may occur. On the other hand, if the cartridge cover is opened too narrowly when the cartridge is removed, it may be difficult to take it out. Furthermore, there is another problem that if the size of the cartridge cover is designed to be smaller, though the grip belt is provided thereon, user's hand may not be put between the cartridge cover and the grip belt.

### SUMMARY OF THE INVENTION

The present invention aims at solving the problems and reducing the size of the filming apparatus for recording information on an optical disc type recording medium.

In one aspect, the filming apparatus of the present invention is constructed such that supporting portions for mounting a grip belt are provided on two structural members (not a cartridge cover) constituting a main body, respectively arranged on both sides of the filming apparatus.

In another aspect, the filming apparatus of the present invention is constructed such that the supporting portions for mounting the grip belt are arranged at a lower position than half of total height of the filming apparatus. In other words, the supporting portions are positioned in the lower region rather than the upper region of the filming apparatus, when it is put on the ground under normal conditions.

In another aspect, the filming apparatus of the present invention is constructed such that the optical disc is inserted or removed vertically with respect to a filming direction.

In another aspect, the filming apparatus of the present invention uses a round-shaped cartridge as a cartridge whose dimension is: 5.2 mm in thickness, 80 mm in length (or width) of the disc plane, and 80 mm+5 mm in width (or length) of the disc plane.

In another aspect, the filming apparatus of the present invention has a cover to encase a cartridge for the optical disc therein, the cartridge having an outer circumferential shape of continuous arcs; and the shape of the surface of the cover in which the cartridge has been loaded is nearly the same as of the surface of the cartridge, when seen from their thickness direction, where the cover and the cartridge being opposed with each other.

In another aspect, the filming apparatus of the present invention is constructed such that the angle between the opened cartridge cover and the filming apparatus to the line along an axis of supporting points of the cartridge cover is within the range from 23° to 34°.

In another aspect, the filming apparatus of the present invention has a motor that allows the cartridge cover to open.

Other and further objects, features and advantages of the invention will appear more fully from the following description.

### BRIEF EXPLANATION OF THE DRAWING

FIG. 1 is a perspective view of a conventional DVD camera

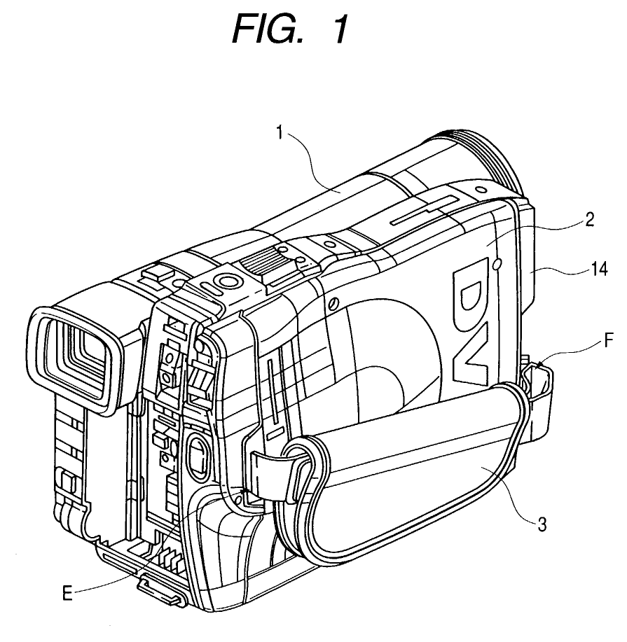

FIG. 2 is a perspective view of the conventional DVD camera 1 in a state that a square-shaped cartridge 4 is taken out therefrom.

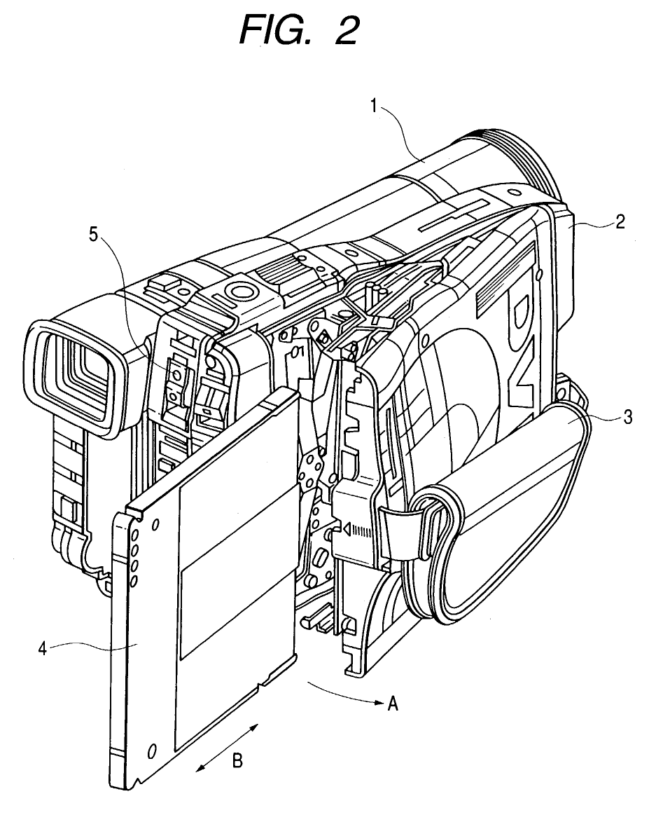

FIG. 3 shows a positional relationship between a disc loading unit 11 of the DVD camera 1 and the square-shaped cartridge 4, at the time of insertion of the latter into the former.

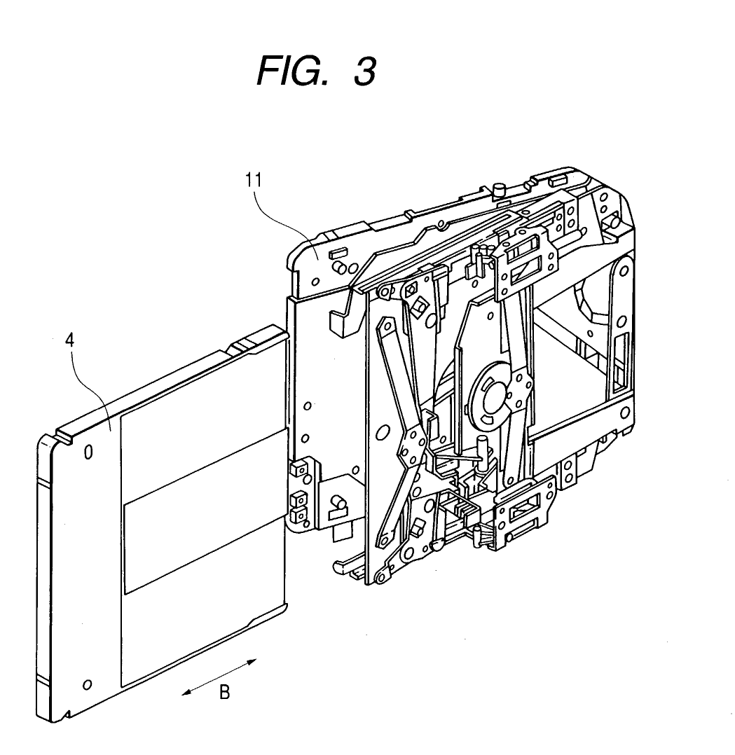

FIG. 4 is an illustration in which the right-lower surface of the cartridge cover 2 of FIG. 2 is arranged to be facing the front.

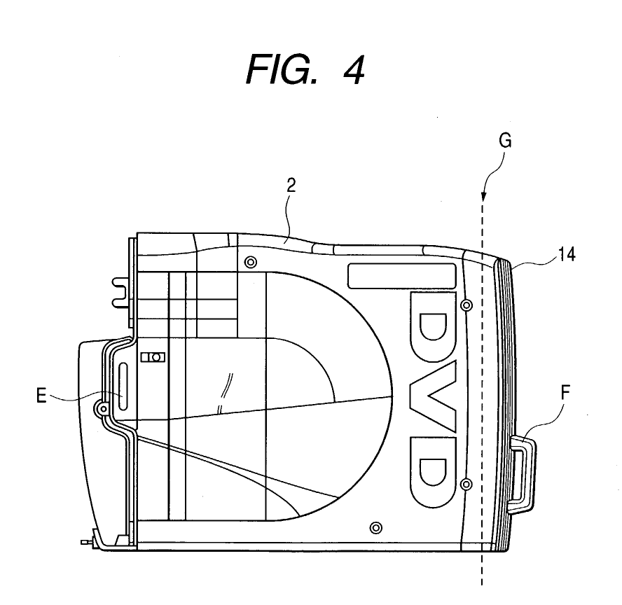

FIG. 5 is a perspective view of a DVD camera 6 according to an embodiment of the present invention.

FIG. 6 is a perspective view of the DVD camera 6, in a state that a round-shaped cartridge 10 as information recording disc is taken out therefrom.

FIG. 7 shows a positional relationship between a disc loading unit 12 of the DVD camera 6 and the round-shaped cartridge 10, at the time of insertion of the latter into the former.

FIG. 8 is an illustration in which the right-lower surface of the cartridge cover 7 of FIG. 5 is arranged to be facing the front.

FIG. 9 is an explanatory illustration of the disc loading unit.

FIG. 10 is an explanatory illustration of the disc loading unit.

### DETAILED DESCRIPTION OF THE PREFERRED EMBODIMENTS

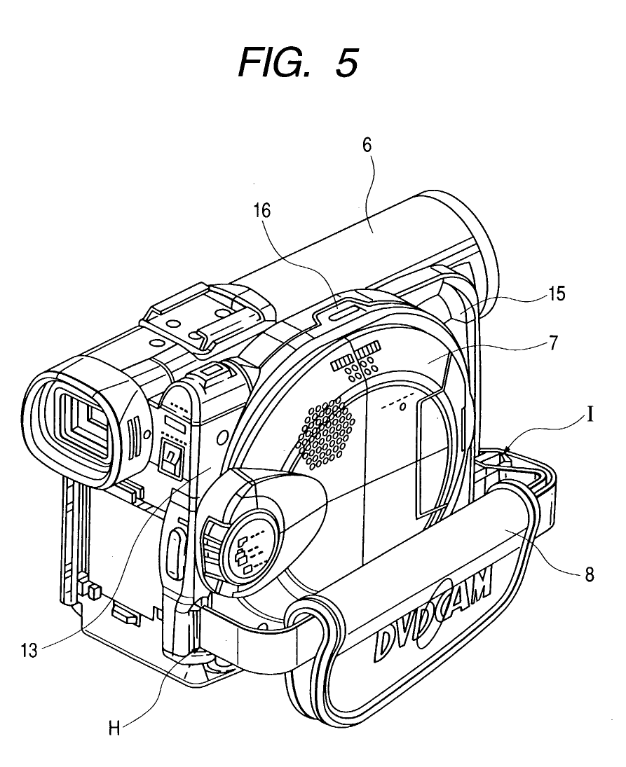

As one embodiment of the present invention, a DVD camera utilizing an optical disc will be explained with reference to FIG. 5 to FIG. 8.

It should be noted that the camera of this embodiment employs a round-shaped cartridge for encasing a 80 mm sized optical disk used to record information thereon. The round-shaped cartridge permits a small sized filming apparatus for recording information. The dimension of the cartridge is: 5.2 mm in thickness, 80 mm in length (or width) of the disc plane, and 80 mm+α mm (from 1 to 9 mm) in width (or length) of the disc plane.

FIG. 5 is a perspective view of the DVD camera 6 of the embodiment of the present invention.

A mechanism for mounting the grip belt supporting portion comprises a supporting portion H constituting a part of a main-body rear end, namely at a cameraperson side, of the camera, and a grip belt 8, being supported at a supporting portion I that is provided on a main-body front end of the camera. A user puts his/her right hand in a grip portion between the grip belt 8 and the cartridge cover 7 to thereby hold the DVD camera 6. Here, the supporting portion H and the supporting portion I are respectively provided on the cameraperson side cover 13 and the lens-side cover 15, which have a strength to constitute the main body. Therefore, it is possible to make up those covers with a plate-thickness to keep the strength. The cartridge cover 7 does not have a supporting portion for holding something, thus enabling the plate-thickness to be made thinner. This permits of downsizing or thinner-sizing for the camera.

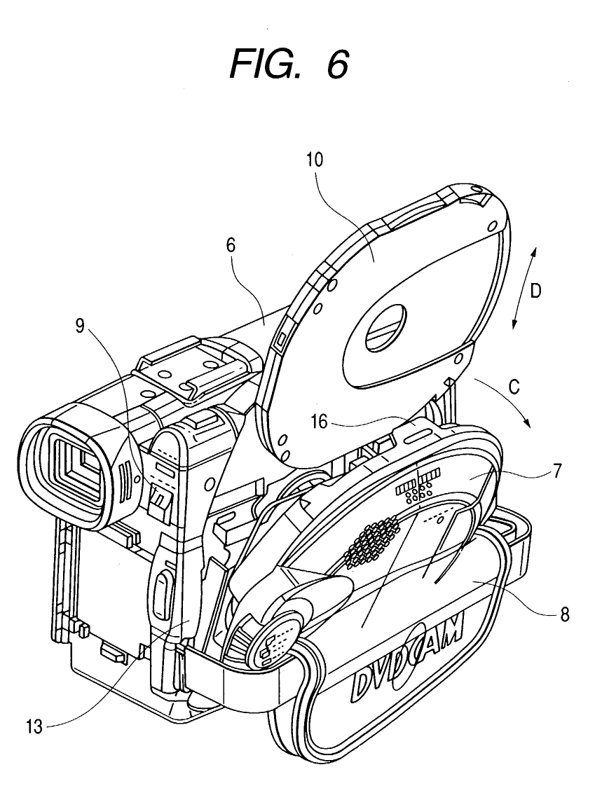

FIG. 6 is a perspective view of the DVD camera 6, in a state that the round-shaped cartridge 10 is taken out therefrom. By operating the cover operation button 9, the cartridge cover 7 is opened into a direction C within a predetermined range of angle, enabling the round-shaped cartridge 10 to be inserted or removed in the direction of D. Setting the opening angle in the direction C within a predetermined range permits of a sufficiently wide angle well considered sizes of user's fingers and thus for a user to easily take out the disk from the cartridge; while permits of a sufficiently narrow angle to prevent a user from a mistake in insertion of the disk into the cartridge.

In addition, the lock mechanism 16 is not subjected to a direct load by the grip belt, it is possible to minimize the reinforcing member. Therefore, the lock mechanism 16 and the peripheral members thereof can be downsized.

Moreover, even when the size of the cartridge cover is designed to be smaller, it is possible to mount a grip-belt having a sufficient length, allowing the user's hand to put therebetween.

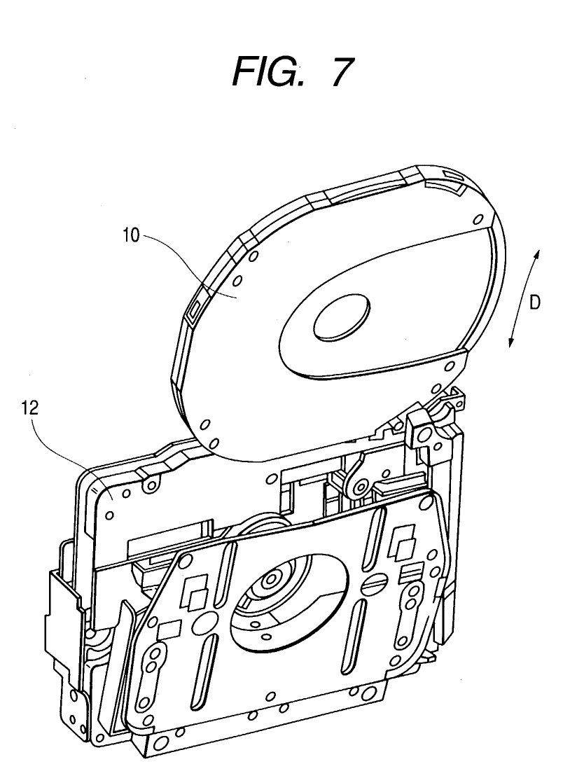

FIG. 7 shows a positional relationship between a disc loading unit 12 of the DVD camera 6 and the round-shaped cartridge 10, at the time of insertion or removal. Similar to the explanation regarding FIG. 6, the round-shaped cartridge 10 is inserted or removed in the direction D.

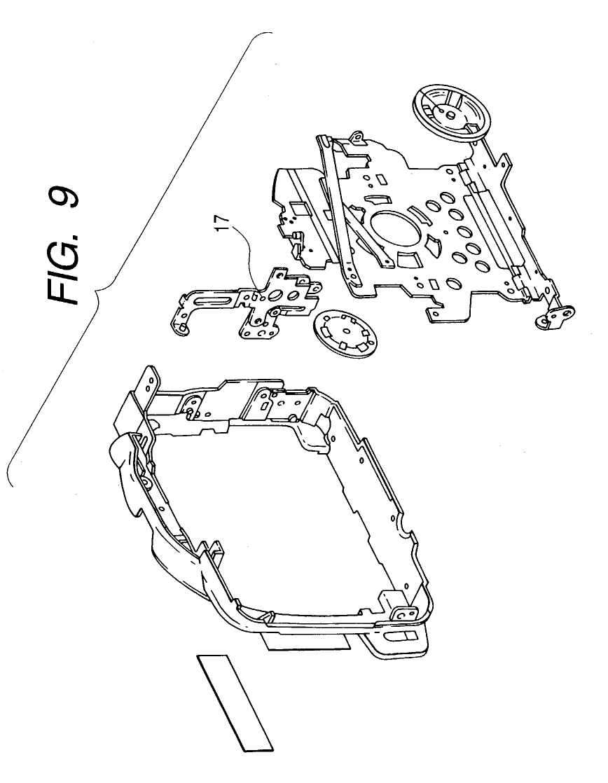

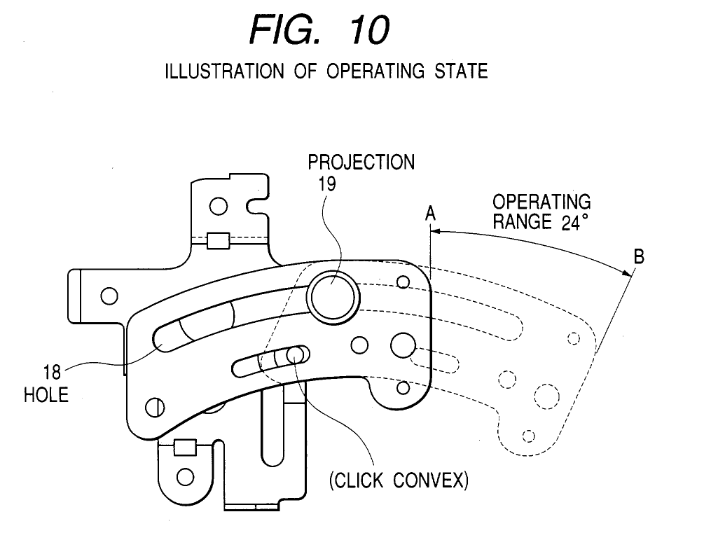

A structure of the disc loading unit 12 of FIG. 7 will be explained with reference to FIG. 9 and FIG. 10. FIG. 9 shows apart of exploded view of the lens-side cover 15. In particular, FIG. 10 shows a backside structure of the portion, which is indicated by arrow 17. In the present embodiment, it is necessary to limit the opening angle of the cartridge cover in the direction C within a predetermined range as indicated by FIG. 6. Considering this point, there is provided a structure where a hole 18 is bored in the plate, and a projection 19 of the cartridge cover is hooked in the hole 18. The opening angle in this case is 24°, as shown FIG. 10. This angle is not limited to 24°, but it is necessary to be between 23° and 34°. By limiting the opening angle in the direction C within a predetermined range, it is possible to secure a sufficiently wide angle considering a size of user's fingers when the cartridge is taken out. At the same time, it is also possible to secure a sufficiently narrow angle for reducing a possibility of wrong insertion, when the cartridge is inserted. It should be noted that a method for limiting the opening angle is not limited to the one as shown in FIG. 10.

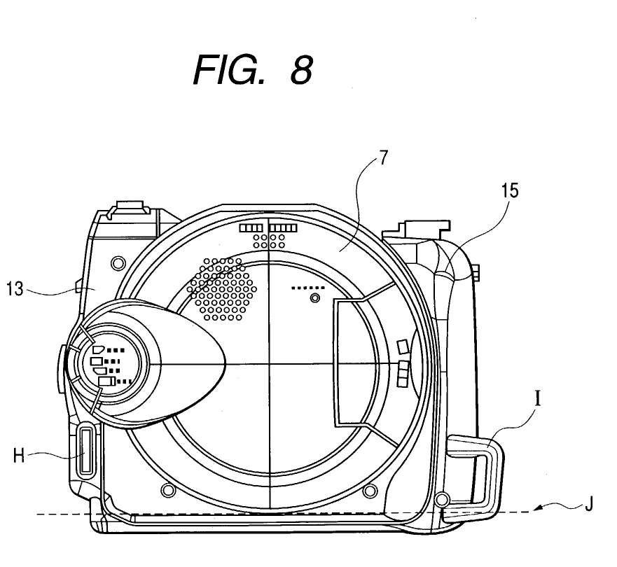

FIG. 8 is an illustration in which the right-lower surface of the cartridge cover 7 of FIG. 5 is arranged to be facing the front. As explained in FIG. 5, the grip belt 8 is supported by the supporting portion H and the supporting portion I. J indicates an axis of the supporting points for opening/closing the cartridge cover 7.

Here, the supporting portion H and the supporting portion I are arranged in the vicinity of the axis of supporting points for opening/closing. In other words, the supporting portion H is positioned in the lower region (ground-side) of the cameraperson-side cover 13 rather than the upper region (sky-side) of the cameraperson-side cover 13, when it is put on the ground under normal conditions. At the same time, the supporting portion I is positioned in the lower region (ground-side) of the lens-side cover 15 rather than the upper region (sky-side) of the lens-side cover 15, when it is put on the ground under normal conditions. In such an arrangement as described above, it is possible to open the cartridge cover 7 within an adequate angle for allowing the round-shaped cartridge 10 to be inserted or removed. As for the opening angle of the cartridge cover, the explanation above can be applied.

According to the present invention, it is possible to downsize a filming apparatus for recording information on an optical disc type recording medium.

The foregoing invention has been described in terms of preferred embodiments. However, those skilled, in the art will recognize that many variations of such embodiments exist. Such variations are intended to be within the scope of the present invention and the appended claims.

What is claimed is:

1. A filming apparatus for filming video/audio information, and recording said video/audio information on an optical disk, comprising:
a cover for loading a cartridge having an outer shape of circular arc, said cartridge encasing an optical disc, wherein,
the shape of the surface of the cover, facing to the surface forming the thickness of the cartridge when the cover is loading the cartridge, is nearly the same as the shape of the surface forming the thickness of the cartridge.

2. The filming apparatus according to claim 1, wherein,
an insertion/removal direction of said cartridge in/from said cover is nearly vertical with respect to a filming direction of said filming apparatus, and
a means for mounting a holding belt for holding said filming apparatus is arranged on a part other than said cover.

3. The filming apparatus according to claim 2, wherein,
said optical disc is a DVD; and
said filming apparatus record said video/audio information on said DVD.

4. An optical disc camera for recording information on an optical disc, comprising:
a loading means for loading an optical disc case arcs for encasing optical disc, having an outer circumferential shape of continuous, wherein,
the outer circumferential shape of a part of said loading means is nearly the same as of a part of said optical disc case.

5. The optical disc camera according to claim 4, wherein,
an insertion/removal direction of said optical disc case in/from said loading means is nearly vertical with respect to a filming direction of said optical disc camera, and
a means for mounting a holding means for holding said optical disc camera is arranged at a part other than said loading means.

6. The optical disc camera according to claim 5, wherein,
said optical disc is a DVD,
said optical disc case is a DVD cartridge, and
said loading means is a cover for loading said DVD cartridge.

7. A DVD camera for recording information on a DVD, comprising:
a cover for loading a holder for encasing said DVD, the holder having an outer circumferential shape of continuous arcs, wherein
said cover also has an outer circumferential shape of continuous arcs.

8. The DVD camera according to claim 7, wherein,
an insertion/removal direction of said holder in/from said cover is nearly vertical with respect to a filming direction of said DVD camera, and
a means for mounting a holding belt used in holding said DVD camera is arranged at a part other than said cover.
